(19) United States
(12) Patent Application Publication
(10) Pub. No.: US 2019/0200654 A1
(43) Pub. Date: Jul. 4, 2019

(54) DEVICE AND METHOD FOR MATURING MEAT IN WATER, IN PARTICULAR BEEF ON THE BONE

(71) Applicant: Moira BIANCO, Gebertingen (CH)

(72) Inventor: Daniel WACHTER, Galgenen (CH)

(21) Appl. No.: 16/330,037

(22) PCT Filed: Aug. 23, 2017
(86) PCT No.: PCT/CH2017/000076

§ 371 Date: Mar. 1, 2019

(30) Foreign Application Priority Data
Sep. 1, 2016 (CH) 01135/16

(51) Int. Cl. A23L 13/40; A23L 13/70

(52) U.S. Cl. CPC A23L 13/432; A22C 17/08; A23L 13/72; A23L 13/428

(57) ABSTRACT

A device for maturing fresh meat, including meat on the bone, such as beef, is illustrated and described which comprises a treatment container with mechanisms for receiving pieces of fresh meat. The device comprises at least one water supply line by which the treatment container can be filled with treatment water in a way that the mechanisms for receiving pieces of meat, and thus the pieces of meat arranged or placed on the receiving mechanisms, are immersed in the treatment water. A method for maturing fresh meat, including meat on the bone such as beef, is also illustrated and described. According to the invention, provision is made that pieces of meat are matured in treatment water, by being completely immersed in treatment water.

### CROSS-REFERENCE TO RELATED APPLICATIONS

This application is a national phase entry under 35 U.S.C. § 371 of PCT/CH2017/000076 filed Aug. 23, 2017, which claims priority to Swiss Patent Application No. 01135/16 filed Sep. 1, 2016, the entirety of each of which is incorporated by this reference.

### TECHNICAL FIELD OF THE INVENTION

The invention comprises a device for maturing fresh meat, including meat on the bone, such as beef and a method for maturing of fresh meat, including meat on the bone, such as beef.

### BACKGROUND OF THE INVENTION

Fresh meat currently is usually placed in vacuum storage. The meat is removed from the bone. This is disadvantageous in that due to the processing, the meat has slice surfaces and thus open pores. Juices can escape and germs can penetrate in. During the storage period, juices, volume and flavor can be lost. Germs which get onto the surface prior to vacuum treatment can multiply in undisturbed fashion. In addition, over the storage time in vacuum, checks and corrective intervention are virtually impossible.

One common alternative method is dry maturing, which is done without vacuum treatment. For this, the meat is hung out for several weeks in a cooler room (for example, at around 3 to 5° C.), with the cooler room moisture regulated to be at a low level. The disadvantages of dry maturing are a very high loss of weight and volume, so-called shrinkage losses. Degradations in flavor go hand in hand with the above-named shrinkage losses. In addition, normally the surface, prior to further processing or consumption, must be removed, through which further carving losses result. Thus, dry maturing results in large carving and shrinkage losses, often to a total of up to 35 percent by weight.

The disadvantages named above are especially manifest with high-quality cuts.

Examples of methods known previously are shown in the following patent disclosure texts:

Patent Disclosure Text GB107593A discloses meat maturation methods in which the meat is dipped into a maturation solution containing a highly concentrated or saturated brine, to which a soluble nitrite (such as an alkali metal nitrite, i.e., sodium or potassium nitrite) is added.

Patent disclosure text US2009/226579A1 discloses a method for preserving meat products (meat, fish, seafood), comprising a softening of the meat product in a cooled solution, which contains water (especially potable water), sodium bicarbonate, an organic acid (such as acetic acid, citric acid and/or lactic acid) and an alkali metal halide (such as sodium chloride). The drained meat product is then placed in a pouch (especially a polyethylene pouch) which is filled with O₂ gas. In one example, for tuna fish, the softening step takes 5 minutes.

Patent disclosure text DE543929C discloses a method for producing frozen fish or frozen meat, which will not lose any juice upon being thawed, or only a small amount. For this, the product to be frozen is treated before freezing with aqueous solutions of alkalis or neutral salts of weak acids, for example hydroxides or citrates of sodium, potassium or ammonium, brought to a pH that is as close as possible to the pH of the living animals or fish, approximately between 6.9 and 7. In especially advantageous fashion, the treatment solution contains cooking salt, as per the example especially a concentration of from 5 to 15%, to increase the osmotic pressure.

Patent disclosure text GB941412A discloses a method and a device for maturing of meat in a brine bath which contains nitrite ions, with the meat being carried in plates through the bath, especially in that each plate on its lower end is attached to a carrier and in essence is drawn the entire way through the bath with its free ends floating, spread upward. The brine especially contains 10 to 32 percent by weight and volume of salt (i.e., sodium chloride) and 0.005 to 1 percent by weight and volume of sodium nitrite.

### Advantages

Therefore it is an advantage to process fresh meat, especially high-quality cuts, in sparing fashion, to maintain flavor, juices and volume during the maturation process. With this, germs should be suppressed from being admitted, growing and propagating.

Additionally, the mineral content of the meat and the salt content of the meat should be maintained as much as possible at the natural level during the maturation process, i.e., to remain as unchanged as possible.

It is especially advantageous to provide an alternative maturation device and/or an alternative maturation process for fresh meat.

### SUMMARY OF THE INVENTION

This invention meets one or more of the foregoing requirements in that it makes available a method and a device for maturation of fresh meat, such as fresh meat on the bone, especially of beef.

The method is characterized in that pieces of meat mature in water, appropriately in that the pieces of meat are submerged in water for maturing. The pieces of meat are fully submerged for a duration of several days or weeks.

The method for maturing of fresh meat is especially characterized in that the pieces of meat mature by being submerged over several days (such as at least two days) or several weeks in treatment water, with the salt concentration in the treatment water being set or regulated for sodium chloride (or cooking salt) at a maximum concentration of 20 g/l, a maximum of 10 g/l, at a maximum of 5 g/l, or at a maximum of 2 g/l. The salt concentration (or total salt concentration) of the treatment water of sodium chloride, potassium nitrate, sodium nitrate, potassium nitrite and sodium nitrite (i.e., the total of the salt concentration of these named salts) is set or regulated to a concentration of a maximum of 20 g/l, a maximum of 10 g/l, a maximum of 5 g/l, or a maximum of 2 g/l. The entire salt concentration of the treatment water (i.e., the sum of salt concentrations of every salt (including sodium chloride, potassium nitrate, sodium nitrate, potassium nitrite, and sodium nitrite) in the treatment water is set or regulated to a concentration of a maximum of 20 g/l, a maximum of 10 g/l, a maximum of 5 g/l, or a maximum of 2 g/l.

The salt concentration of sodium chloride and/or salts overall in the treatment water lies in the range from 0.1 g/l to 20 g/l, 0.1 g/l to 10 g/l, 0.1 g/l to 5 g/l, 0.1 g/l to 2 g/l, or 0.5 g/l to 2 g/l.

The salt concentration of sodium chloride, potassium nitrate, sodium nitrate, potassium nitride and sodium nitrite in toto and/or of salts overall in the treatment water is in the range from 0.1 g/l to 20 g/l, 0.1 g/l to 10 g/l, 0.1 g/l to 5 g/l, 0.1 g/l to 2 g/l, or 0.5 g/l to 2 g/l.

During the maturation treatment, appropriately the meat does not come in contact with any higher concentrated salt solution than the above-described treatment water.

Pieces of meat treated and matured according to the invention are tender and able to be processed particularly well, especially these are easily able to be processed using knives. During the maturation treatment, the meat undergoes little or no weight loss, also especially little or no loss of juices or flavor. Prior to further processing, the surfaces of the pieces of meat treated in water do not have to be removed, because they undergo little or no change in the water. Especially the surfaces of the pieces of meat do not harden during water maturation. Thus overall due to the maturation treatment, there is little or no carving and shrinkage loss. In addition, even after water maturation, the meat remains easily manually manipulable by a knife.

Either alone or in combination with one another, the embodiment versions presented in what follows result in further improvements of the method.

Advantageously in one embodiment the method is further characterized in that the salt concentration of the water is controlled. Thus one invention-specific version discloses a method for maturing of fresh meat which is characterized in that pieces of meat mature in water by submerging the meat pieces in saline water, the salt concentration of which is controlled. The salt concentration of the water is especially controlled in that it is set and/or regulated, especially set and/or regulated to a certain value. For one thing, at the start of the maturation treatment, treatment water made available is set to a predetermined salinity and/or, for another, during the ongoing maturation treatment, the salinity of the treatment water can be checked, and corrected by additional dosing, dilution and/or salt removal (ion removal) and reset or regulated. The current salt concentration of the water can, for example, be determined or assessed by means of a conductance measurement.

The salt content of the treatment medium ideally is set and regulated in such a way that the osmotic pressure is or remains in equilibrium, and thus, water neither flows out of, nor into, the meat (or the meat neither expels nor admits water). Especially, the volume and weight of the pieces of meat remain constant thereby.

In practice, salt brines are added and regulated in the parts per thousand range, to keep the osmotic pressure between the treatment medium (water) and the meat in equilibrium. Caution is necessary so that additional dosing does not go over the salt and mineral concentration in the meat itself, so that the reverse effect, namely a removal of juices from the meat (similar to raw pickled products) occurs. If only pure water were used, the meat would fully saturate with water.

According to one advantageous embodiment, the salinity of the water is set and/or regulated by addition of salt, especially NaCl or a pickle salt mixture to a concentration at which the osmotic pressure between the aqueous and saline treatment medium and the meat is mutually compensated. Especially, there should thus be no osmotic pressure between the meat and the treatment medium surrounding the meat.

Ideally the salinity of the treatment medium should be set or regulated to a value similar to the salinity of the pieces of meat (i.e., the natural salt content of meat, especially fresh meat). In practice it is appropriate essentially to determine the electrical conductivity of the treatment water and compare it with the electrical conductivity of the meat or the meat juices (especially of the fresh meat) or an expected guideline for meat or meat juice. Thereupon—if necessary—the conductivity value of the treatment medium can be set through addition of salt (such as in essence of NaCl) for the treatment medium to that of the meat or meat juice or to a standard value. One advantageous standard value is 400 mS/m+/−150 mS/m (millisiemens per meter). Appropriately the electrical conductivity to be set of the treatment water (treatment medium) is in the range from 100 mS/m to 700 mS/m, further in the range from 200 mS/m to 600 mS/m, or in the range from 250 mS/m to 550 mS/m.

According to an advantageous embodiment, the salt concentration of the water is set by addition of at least sodium chloride (i.e. cooking salt or table salt), or a mixture of sodium chloride and sodium nitrite, especially by addition of nitrite pickling salt. Pickling salt is a table salt with an addition of about 0.4% to 0.5% by weight of sodium nitrite.

According to an advantageous embodiment, the salinity of the water in sodium chloride is set and/or regulated to a concentration of 0.1 g/l to 20 g/l, 0.1 g/l to 10 g/l, 0.1 g/l to 5 g/l, 0.1 g/l to 2 g/l, or 0.5 g/l to 2 g/l.

According to an advantageous embodiment, the salinity of the water is set and/or regulated by addition essentially of sodium chloride or a mixture of sodium chloride and other salts (for example, sodium chloride and at least sodium nitrite), especially a mixture containing at least 75% by weight of sodium chloride, at least 80% by weight of sodium chloride, at least 90% by weight of sodium chloride, f at least 95% by weight of sodium chloride, or at least 98% by weight of sodium chloride.

According to an appropriate embodiment, the salinity of the water is set by addition of a mixture of sodium chloride and sodium nitrite, especially one such mixture containing 98% by weight of sodium chloride. Alternatively, a sea salt composition could be used.

By setting and regulating the salt content in the treatment medium, a leaching or weight loss of the meat can be avoided. Thus a loss of juices can be avoided overall.

Meat on the bone is used with particular advantage. It has hardly any slice surfaces and thus hardly any open pores due to processing damage. The tendency to lose juices in these cuts of meat is further reduced and still more controllable.

According to an advantageous embodiment, sterilized water is used and/or the water is sterilized, preferably repeatedly, especially at regular intervals. This especially includes removal of bacteria, such as Legionella, but also viruses, cells, proteins, macromolecules and other high-molecular-weight substances.

According to an advantageous embodiment, for sterilization purposes, the water is prepared in a rotary circulation pattern, especially prepared repeatedly and reused, in that the used treatment medium is withdrawn from the treatment container, prepared, and after preparation, brought back into the treatment container. The preparation is appropriately conducted while the pieces of meat are submerged in the treatment medium.

According to an advantageous embodiment, the preparation of the water includes at least one of the following steps: mechanical filtration, ultrafiltration, ultraviolet radiation, salinity regulation, or a combination of these.

According to an advantageous embodiment, from the treatment container, at least one water volume, which corresponds to double the volume of a treatment container, is removed, prepared and returned to the treatment container. The named water volume is removed from the treatment container in a continuous rotary circulation pattern, prepared, and returned to the treatment container.

According to an advantageous embodiment, the water is repeatedly prepared, at regular intervals, especially daily.

According to an advantageous embodiment, the water is cooled vis-à-vis room temperature.

According to an advantageous embodiment, the water is set in the treatment container to a temperature between 0° C. and 10° C., between 0° C. and 7° C., between 0° C. and 5° C., between 0° C. and 3° C., between 0.5° C. and 1° C., or between 0.1 and 0.5° C.

According to an advantageous embodiment, the meat is submerged for several days or at least a week. Appropriately the meat is submerged for a maximum of up to 10 weeks.

In one exemplary maturation method, the treatment water in the treatment container is replaced by a freshly prepared treatment medium with a treatment duration of multiple weeks, for example with a treatment of at least five weeks, at least once a week, via a rotary circulation pattern, while the cuts of meat remain submerged in the treatment medium.

In a further exemplary maturation method, the treatment water is circulated daily out of the treatment container by repreparation devices, with a volume content of at least two treatment containers being circulated by the repreparation devices back to the treatment container, while the pieces of meat remain submerged in the treatment medium.

In one fashion, the pH of the water or of the treatment medium is in, or close to, the neutral range, especially in the range from pH 6 to pH 9 or in the range from pH 6.5 to pH 9, further in the range from pH 6 to pH 8 or in the range from pH 6.5 to pH 8, or in the range from pH 6.5 to pH 7.5. Regulation of the pH can be provided. However, in most cases, for quality assurance reasons, it suffices to check and document this.

The device includes a treatment container with devices to admit pieces of fresh meat, and is characterized in that the device contains at least one water supply line, by means of which the treatment container can be filled with water, so that the devices to admit cuts of meat and thus the cuts of meat arranged or placed on the devices for admission, are submerged in water. Especially the cuts of meat are fully submerged in water.

According to the invention, this device permits pieces of meat to mature in water (hereinafter also called treatment water or treatment medium). During the maturation treatment, the meat loses no weight thereby. After the maturation process, the matured meat in principle can be immediately prepared for consumption, i.e. for example by being roasted or fried. Prior to being used or further processed, the surface of the treated cuts of meat can possibly be trussed, i.e. prepared for the store, or be sliced and/or made store-ready for roasting.

Either alone or in combination with one another, the embodiment versions presented in what follows, result in further improvements of the device.

According to an advantageous embodiment, the device includes at least one device for adding salt to the water, especially at least one device for regulation of the salinity of the water.

According to an advantageous embodiment, the device includes at least one arrangement for determination of the electrical conductivity of the treatment water. Appropriately, the arrangement for regulating salinity of the water and the arrangement for determination of the electrical conductivity of the treatment water are connected, so that the arrangement for regulation of the salinity of the water can have access to measured values of the device for determination of the electrical conductivity, to govern the additional dosing of salts.

According to an advantageous embodiment, the device includes an arrangement for water preparation, especially an arrangement for preparation and cleansing of the treatment water, especially for purification of the treatment water. The water preparation arrangement is especially configured so that it can be operated while the pieces to be treated are submerged in the treatment water.

According to an advantageous embodiment, the arrangement for water preparation or the arrangement for purification contains one or more of the following elements: one or more filter arrangements, especially for mechanical filtration and/or for ultrafiltration, and/or ultraviolet irradiation device.

According to an advantageous embodiment, the treatment container includes a water drain which empties into an annular water line which, via at least arrangements for water preparation and/or arrangements for regulating the salinity of the water, leads back to the treatment container.

According to an advantageous embodiment, the device includes an arrangement for cooling of the water. The treatment container may be situated in or integrated into a cooling room.

According to an advantageous embodiment, the device, especially the treatment container, has available at least one fresh water intake line.

According to an advantageous embodiment, the fresh water intake line leads via an antechamber into the treatment room, with the antechamber equipped with an arrangement for addition of salt to the water, or for setting the salinity of the water.

According to an advantageous embodiment, the arrangements for admitting pieces of fresh meat is so configured that at least 95%, or at least 99% of the surface of the piece of meat is in direct contact with water, the treatment medium. An arrangement for admitting cuts of meat can, for example, contain a rack with choppers and/or spits. The water layer which surrounds the individual cut of meat, appropriately should, at each location of the meat surface in the direction perpendicular to the surface of the cut of meat, be at least 1 cm, 3 cm, or 5 cm deep. This makes possible an ideal water exchange. Therefore, the device is designed in appropriate fashion so that a water layer is at least 1 cm, at least 3 cm, or at least 5 cm deep.

Overall, the invention-specific device makes possible a maturation technology for maturing of fresh meat on the bone.

Experience has proven that contact of water with fresh meat can be viewed as the cause of contamination by germs. In addition, the transfer of germs is amplified by water. Overall, water is a transport medium, and cannot, by itself, be disqualified from being a germ source. However, based on the preparation options shown here, germs can be prevented or at least hindered from building up, and kept in check.

Volume, juices and weight are outstandingly maintained during the invention-specific fresh meat maturation process. The appropriately used monitoring and preparation technologies for the treatment medium make it possible to obtain optimal results for every batch. In advantageous fashion, the monitoring and preparation technologies for the treatment medium are fully automated.

Here and hereinafter, wherever the ranges are indicated, further ranges derive from combinations of the minima and maxima named in the ranges.

The named optional features can be implemented in any combination, as long as they do not mutually exclude each other.

Additional advantages of the present invention are derived from the following specification.

### BRIEF DESCRIPTION OF THE FIGURES

Additional embodiments of the invention are derived from the specification that now follows using the FIGURE. Shown in a schematic depiction is:

FIG. 1: a device for maturing of meat

### DETAILED DESCRIPTION OF THE INVENTION

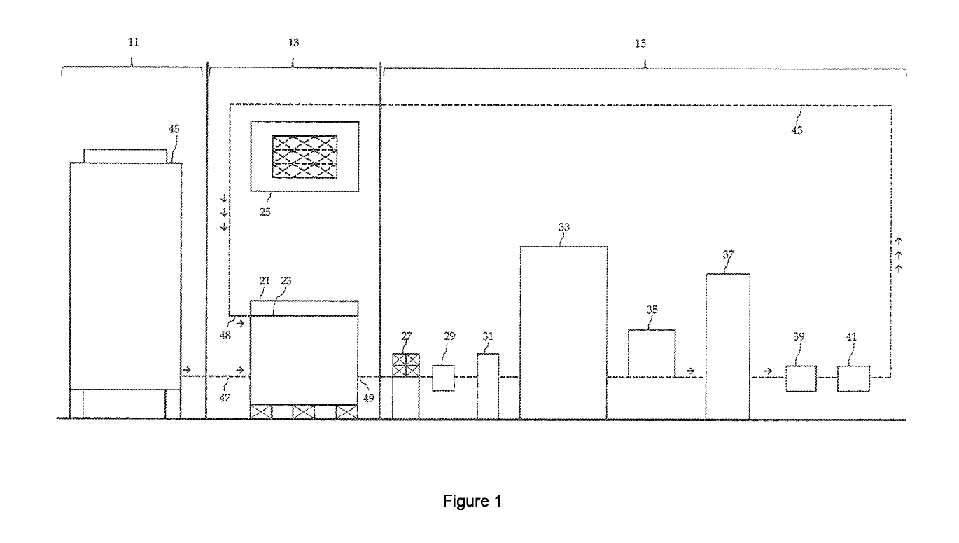

A maturing system is displayed in FIG. 1. This essentially includes a treatment container 21 which can be filled with a liquid treatment medium, in particular water, to completely submerge the piece of meat to be treated. The level of water 23 in the container can be appropriately regulated so that during the treatment of the meat it stays above the pieces of meat located in container 21.

The treatment medium essentially includes water which is appropriately set to a certain salt content. In feed tank 45 for example the treatment medium can be prepared while the salt content of the treatment medium is being set before it is conducted via feeding line 47 into treatment area 21.

The salt content of the treatment medium is ideally set so that the osmotic pressure is in equilibrium or so that water flows neither into the meat nor out of the meat. In particular the volume and weight of the piece of meat should remain constant.

The treatment medium is allowed to enter treatment container 21 via feeding line 47. The treatment medium can be diverted from the treatment container via outlet 49. The diverted treatment medium can optionally be processed and fed back via a second feeding line 48 into the treatment container 21 to be reused. The processing and return feeding of the treatment medium is brought about by a circulation system (in particular a water circulation system). For this purpose a ring feeding 43 is set up which feeds from outlet 49 by various processing units and analysis units, as the case may be, into treatment container 21.

Diverted treatment medium can alternatively be totally or partially discarded or removed from the circulation system via a discard valve 29. The discard valve 29 can be set up in ring feeding 43.

A supply pump 27 which can be advantageously installed in ring feeding 43, directly after outlet 49, takes care of the transport of the treatment medium in the circulation system.

Water processing equipment can include salt regulation devices 41, filtering devices 31, 33, ultraviolet radiation 37 etc.

In the maturing system according to FIG. 1, the following processing equipment and analysis devices are included in the circulation system:

The processing equipment includes one or more filtering devices:

advantageously a pre-filter 31, e.g. a micro-filter for filtering larger foreign particles, particularly those over 0.1 μm, and

a filter 33, e.g. an ultrafilter to filter out macromolecules, bacteria, viruses, legionellae, cells, proteins and other high-molecular substances, in particular to filter out particles in the range of roughly 0.1 to 0.01 μm. In the ultra-filter, in particular a membrane is used (an ultrafiltration membrane) with pores smaller than 20 nanometers.

Ions of salts, in particular sodium (Na⁺), magnesium (Mg²⁺), calcium (Ca²⁺), potassium (K⁺), chloride (Cl⁻), sulfate (SO₄²⁻) and nitrites (NO²⁺), should not be filtered out by the filters. The filters being used should advantageously allow ions to essentially pass, in particular those ions which are customarily derived from seas salts, table salts or pickling salts.

Salt ions can optionally be filtered out, in particular e.g. with a nano-filter for particles of 0.01 μm to 0.0001 μm and by means of reverse osmosis for even smaller particles. In this case the salt content should be recalibrated or reset after filtration.

Pre-filters, ultrafilters and any additional filters are used in dead-end operations. The treatment medium deriving in particular from the treatment tank flows into the capillary line; pure water (filtrate) passes through the filtering membrane, the other substances are held back on the membrane's upper surface. The other substances form a coating on the membrane. To remove the coating, the membrane is back-flushed at regular intervals, as a fully automated process.

The processing equipment contains an additional dosage unit 41. In the additional dosage unit 41, for example, salts may be added to the treatment medium to adjust or recreate the desired composition of the treatment medium, or to keep it constant or manipulate it as desired. By using an analysis or control device 39, relevant parameters, such as the conductivity of the treatment medium already partly reprocessed here, are measured. The additional dosage unit 41 is controlled by the analysis or control device 39, so that the dosage can be controlled depending on the currently measured parameters of the treatment medium. In the setup example currently being discussed, according to FIG. 1, a conductivity measurement 39 is used to analyze the treatment medium and control the additional dosage unit 41.

The additional dosage unit 41 is advantageously in the direction of the flow of the analysis and control device 39 and thus reset in particular to the conductivity measurement 39.

In the additional dosage unit 41 advantageously at least sodium chloride, e.g. brine, is added.

The maturing system also optionally includes a measurement unit 35 to analyze and log the treatment medium. Measurement unit 35 serves in particular to determine the temperature of the treatment medium, the pH value of the treatment medium, the conductivity of the treatment medium, and/or the concentration of different ions or other substances in the treatment medium. The logging of values in particular serves the quality assurance and quality certification of the product being generated. Such a measurement unit 35 could be done as an alternative or a supplement to additional dosage 41. The logging occurs at regular intervals over the course of the entire maturing treatment.

The conductivity measurement 39, the ultraviolet radiation unit 37 and/or the additional dosage unit 41 and any additional measuring unit 35 are in the direction of the flow of the treatment medium in ring circuit 43 (outward after exiting and into the treatment container before re-entering), set to filtering units 31, 33.

The processing equipment includes an ultraviolet radiation unit 37 which is applied to disinfect the treatment medium, by which the germ count (bacterial concentration) is significantly reduced. This occurs in the direction of the flow after filtration.

The treatment container 21 is located in a cooler room 13, while the reprocessing equipment and any measuring units are located outside the cooler room, in particular in a separate utility room 15. In the cooler room 13, there is advantageously a refrigeration unit is provided to cool the treatment medium. The refrigeration unit 25 is in the cooler room 13 but positioned outside the treatment container 21. The distribution in cooler room 13 and utility room 15 for example is advantageous with maintenance and repair work on the reprocessing devices 31, 33, 37, 39, 41, on measuring devices 35 or pump 27 and outlet valve 29. In this way the cooler room can also be kept small.

The reprocessed treatment medium which is fed back via a circular feeding 43 to the treatment container 21 is cooled through cooler room 13 on its way to circular feeding 43 to treatment temperature before it flows into treatment container 21.

An alternative cooling of the water inside the treatment container is conceivable. The treatment container could, for example, function as a cooler.

Feeding tank 45 can be set up in cooler room 13 or advantageously in a separate pre-cooling 11.

On the basis of a combination of cooling and ultrafiltration and/or ultraviolet filtration, it manages to keep the germ count low despite a relatively low germ count and an essentially neutral pH count of the treatment medium or reduce it to a minimum. There is no need to resort to preservation material and/or oxidation material in the treatment room.

Following this there will be an explanation of the invention using examples.

### Example 1

A treatment medium based on water with a table salt concentration in the range of 0.1 g/l to 2 g/l, or 0.1 g/l to 0.5 g/l is prepared in feeder tank 45.

Fresh meat, essentially fresh muscle meat (in particular pieces of meat on the bone) from beef are arranged in treatment container 21, e.g. by hanging or by laying down on holding devices for pieces of meat. The weight per piece lies advantageously in the range of 1 to 50 kg, especially between 1 and 30 kg, however these ranges have some leeway more or less. It is best if for each load all pieces have as similar weight as possible so that a similar treatment can be applied for all.

Treatment container 21 is flooded with treatment medium from feeder tank 45 until all pieces of meat are submerged in the treatment medium.

The temperature of the treatment medium in treatment container 21 is kept as stable as possible in the range of 0° to 5° C.

After a week the treatment medium in treatment container 21 is replaced with a freshly prepared treatment medium. This treatment is repeated once a week over the next 5 to 10 additional weeks (depending on the desired degree of maturity at consumption). After this the pieces of meat are removed from treatment container 21 and stored hanging to dry in the cooler room for at least a day. After that the pieces of meat are ready for further processing and/or consumption.

### Example 2

A treatment medium based on water with a table salt concentration in the range of 0.1 g/l to 2 g/l, or 0.1 g/l to 0.5 g/l is prepared in feeder tank 45.

Fresh meat, essentially fresh muscle meat (in particular pieces of meat on the bone) from beef are arranged in treatment container 21, e.g. by hanging or by laying down on holding devices for pieces of meat. The weight per piece lies advantageously in the range of 1 to 50 kg, especially between 1 and 30 kg, however these ranges have some leeway more or less. It is best if for each load all pieces have as similar weight as possible so that a similar treatment can be applied for all.

Treatment container 21 is flooded with treatment medium from feeder tank 45 until all pieces of meat are submerged in the treatment medium.

The temperature of the treatment medium in treatment container 21 is kept as stable as possible in the range of 0° to 5° C.

The treatment medium 21 is circulated daily for about a half hour from the treatment container through the reprocessing devices (as shown in FIG. 1), whereby at least a volume content of two treatment containers 21 is circulated through the reprocessing devices back to treatment container 21.

During the reprocessing activity the water level 23 of the treatment medium in treatment container 21 is advantageously kept over the pieces of meat to be treated so that the pieces of meat remain submerged in the treatment medium.

The reprocessing devices being used include:

a pre-filter and

an ultrafilter

a measurement and analysis device after the filtering to determine the pH and salt concentration of the table salt, including correction of the treatment medium by additional dosages of table salt and adjustment of the pH value. The content of the salt (NaCl) of the treatment medium is thereby analyzed and the value referred to above is set.

an ultraviolet radiation unit to disinfect the treatment medium by radiating it with ultraviolet light.

This treatment is carried out over the course of several weeks. The treatment medium is shown to be circulated for half an hour through the reprocessing devices (as displayed in FIG. 1). After several weeks have elapsed the pieces of meat are removed from the treatment room 21 and stored to dry for at least a day. After that the pieces of meat are ready for further processing and/or consumption.

### Examples 3 and 4

Application examples 1 and 2 are carried out with a mixture of pickling salt instead of with table salt alone. The mixture of pickling salt includes essentially table salt with a small addition of calcium and/or, sodium nitrate, potassium nitrite and sodium nitrite consist of altogether less than 10% by weight, less than 5% by weight, or less than 1% by weight of the table salt amount. The treatment medium based on water includes the mixture of pickling salt referred to in a concentration of 0.101 g/l to 0.505 g/l, 0.105 g/l to 0.525 g/l or 0.11 g/l to 0.55 g/l.

While these specific forms of applications are being described, it is obvious that different combinations of the application possibilities depicted could be used, to the extent that the application possibilities are not mutually exclusive.

While the invention is described here with reference to specific application forms, it is obvious that changes, modifications, variations and combinations can be made without deviating from concepts of the invention.

1. A method for maturing fresh meat, including meat on the bone, such as beef, comprising:
submerging pieces of meat in treatment water in a treatment container for a plurality of days, a salt concentration of sodium chloride in the treatment water being set or regulated at a concentration of at least 0.1 g/l to 20 g/l.

2. The method of claim 1, wherein the treatment water comprises a concentration of sodium chloride, potassium nitrate, sodium nitrate, potassium nitrite, and sodium nitrite set or regulated to a concentration of at least 0.1 g/l to a 20 g/l.

3. The method of claim 1, wherein the salt concentration of the treatment water is set or regulated to a concentration of at least 0.1 g/l to 10 g/l.

4. The method of claim 1, further comprising checking the salt concentration or an electrical conductivity of the treatment water and setting or regulating the salt concentration or the electrical conductivity of the treatment water is accordingly.

5. The method of claim 1, further comprising adding salt to the treatment water to set or regulate the salt concentration of the treatment water, whereby an osmotic pressure is in equilibrium between the treatment water and the pieces of meat.

6. The method of claim 4, wherein the electrical conductivity is between 100 mS/m to 700 mS/m, or is set to a value of the respective range.

7. The method of claim 1, further comprising, setting the salt concentration of the treatment water by adding at least sodium chloride, or at least a mixture of sodium chloride and sodium nitrite.

8. The method of claim 1, wherein the salt concentration of the treatment water in sodium chloride is set or regulated to a concentration of 0.1 to 5 g/l, 0.1 g/l to 2 g/l, further or 0.5 g/l to 2 g/l.

9. The method of claim 1, further comprising, setting or regulating the salt concentration of the treatment water by adding at least sodium chloride or a mixture of sodium chloride and other salts, in a mixture containing at least 75% by weight of sodium chloride or a comparable mixture of sodium chloride and sodium nitrite.

10. The method of claim 1, further comprising, processing the treatment water for disinfection or salt regulation.

11. The method of claim 1, further comprising, processing the treatment water by least one of mechanical filtration, ultrafiltration, ultraviolet radiation, regulation of salt concentration or a combination thereof.

12. The method of claim 1, wherein a water volume corresponding to a volume of double a capacity of the treatment container is removed from the treatment container, processed and fed back to the treatment container.

13. The method of claim 1, further comprising, repeatedly preparing the treatment water at regular intervals.

14. The method of claim 1, further comprising, cooling the treatment water with respect to a room temperature with the treatment water in the treatment container is set to a temperature between 0° C. and 10° C.

15. The method of claim 1, further comprising setting or regulating a, pH of the treatment water to be pH 6 to pH 9.

16. The method of claim 1, further comprising submerging the pieces of meat for at least a week.

17. A device for maturing meat, including meat on the bone such as beef, comprising:
a treatment container configured to receive pieces of fresh meat,
a water-feeding line configured to fill the treatment container with treatment water until the pieces of meat in the treatment container are submerged in the treatment water,
equipment to regulate a concentration of sodium chloride or a mixture of sodium chloride, potassium nitrate, sodium nitrate, potassium nitrite and sodium nitrite in the treatment water to a total concentration of at least 0.1 g/l to 20 g/l.

18. The device of claim 17 further comprising a system to process and disinfect the treatment water.

19. The device of claim 18, wherein the system comprises at least one of a mechanical filtration system, an ultrafiltration system or and ultraviolet radiation system.

20. The device of claim 17, wherein the treatment container comprises water tubing that leads to a water circulation line, which leads back to the treatment container via the system to process the treatment water or the equipment to regulate the salt concentration of the treatment water.

21. The device of claim 17 further comprising a cooling system contains configured to cool the treatment water.

22. The device of claim 17, further comprising a fresh water line configured to provide fresh water to the treatment container.

23. the device of claim 22, wherein the fresh water line leads to a treatment room via an antechamber whereby the antechamber is comprises salt adding equipment to add salt to the water.

24. The device of claim 17, further comprising testing equipment configured to determine an electrical conductivity of the treatment water.
